(19) United States
(12) Patent Application Publication
(10) Pub. No.: US 2016/0029607 A1
(43) Pub. Date: Feb. 4, 2016

(54) DEVICE, SYSTEM, AND METHOD OF USE FOR ATTRACTING AND CATCHING FISH

(71) Applicant: William Elsworth Mixon, III, Corpus Christi, TX (US)

(72) Inventor: William Elsworth Mixon, III, Corpus Christi, TX (US)

(21) Appl. No.: 14/815,958

(22) Filed: Aug. 1, 2015

Related U.S. Application Data
(60) Provisional application No. 62/032,506, filed on Aug. 1, 2014.

(51) Int. Cl. A01K 97/02; A01K 83/00; A01K 99/00; A01K 91/00; A01K 97/12

(52) U.S. Cl. CPC A01K 97/02; A01K 91/00; A01K 97/12; A01K 99/00; A01K 83/00

(57) ABSTRACT

A fish attracting and catching device, system, and method of use is disclosed herein, which utilizes an illuminated clear bait containment shell in conjunction with a trolley casting system. In an embodiment the fish attracting and catching device and system is comprised of a shell wherein said shell is comprised of a flotation portion, a hooking portion, an illumination portion, and a bait holding portion. In another embodiment, the bait holding portion is comprised of at least one submersible opening to aid in the bait holding portion filling and releasing water. In another embodiment, the shell is further comprised of a handle portion. In yet another embodiment the fish attracting and catching device and system is comprised of a trolley system. In an embodiment, the trolley system is comprised of a trolley line and a trolley weight.

### CROSS-REFERENCE TO RELATED APPLICATIONS

This application claims the benefit under Title 35 United States Code §119(e) of U.S. Provisional Patent Application Ser. No.: 62/032,506; Filed: Aug. 1, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to a device, system, and method of use for attracting and catching fish. More specifically, the present invention relates to a device, system, and method of use for attracting and catching fish comprising an illuminated clear bait containment shell in conjunction with a trolley casting system.

### BACKGROUND OF THE INVENTION

Without limiting the scope of the disclosed device and method, the background is described in connection with a novel device, system, and approach for a fish attracting and catching system.

The field's prior art reflects many approaches and devices in providing a means for attracting and catching fish.

A first example of a fish attraction device in the prior art is described in U.S. Pat. No. 6,226,917 issued on May 8, 2001 to Brian P. Sylla et al. In this example, the device is comprised of a fishing lure having a wire frame forming a receptacle which realeasably receives and holds an elongated insert, which may be an illumination device. A drawback to this approach is that the light source remains with the hook and when a fish is caught, the bait and the light source are both reeled in. In addition, there is no mechanism to assist with the casting process of the user.

A second example of a fish attraction device in the prior art is described in U.S. Pat. No. D381,734 issued on Jul. 29, 1997 to Cline J. Murphy. In this example, the device is directed to a submersible fish attracting light. A drawback to this approach is that it is only a light source that can be submerged and is segregated from any bait source.

In view of the foregoing, it is apparent that there exists a need in the art for a device, system, and method of use for a fish attracting and catching system, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides a device, system, and method of use for a fish attracting and catching system. That is, a device, system, and method of use for attracting and catching fish comprising an illuminated clear bait containment shell in conjunction with a trolley casting system.

In one embodiment, the fish attracting and catching device or system is comprised of a shell wherein said shell is comprised of a flotation portion, a hooking portion, an illumination portion, and a bait holding portion. The flotation portion assists in setting the depths the shell will position itself. That is, depending on the buoyancy of the flotation portion and the weight in the shell, the shell may remain at the surface or at carrying depths down to the floor of the body of water. In another embodiment, the bait-holding portion is comprised of submersible openings to aid in the bait-holding portion filling and releasing water and also increases the scent release of the bait. In an embodiment, the illumination portion is comprised of a light source such as an LED light, which is positioned within the shell. In another embodiment, the shell is further comprised of a handle portion to assist in carrying and positioning the shell. In yet another embodiment the fish attraction and catching device or system is further comprised of a trolley system. The trolley system in an embodiment is comprised of a trolley line and a trolley weight. In an embodiment, the trolley weight is comprised of an attachment component which may be a swivel barrel connector. In an embodiment, the trolley system allows the user of the system to trolley his or her line down to the shell for fishing.

It is an object of the invention to provide a means of attracting fish by utilizing bait and/or illuminated objects. It is another object of the invention to provide an easy means of casting which allows those that are handicapped, small children, elderly, and mentally challenged to fish.

In summary, the present invention discloses an improved device, system, and method of use for a fish attracting and catching system. More specifically, the present invention relates to a device, system, and method of use for attracting and catching fish comprising an illuminated clear bait containment shell in conjunction with a trolley casting system.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is a front perspective view of one example of the fish attracting and catching device in accordance with the teachings of the present disclosure;

FIG. 2 is a front view of one example of the fish attracting and catching device in accordance with the teachings of the present disclosure;

FIG. 3 is a back view of one example of the fish attracting and catching device in accordance with the teachings of the present disclosure;

FIG. 4 is a left side view of one example of the fish attracting and catching device in accordance with the teachings of the present disclosure;

FIG. 5 is a right side view of one example of the fish attracting and catching device in accordance with the teachings of the present disclosure;

FIG. 6 is a top side view of one example of the fish attracting and catching device in accordance with the teachings of the present disclosure;

FIG. 7 is a bottom side view of one example of the fish attracting and catching device in accordance with the teachings of the present disclosure;

FIG. 8 is a side view of one example of the trolley weight utilized as a component of the fish attracting and catching device or system in accordance with the teachings of the present disclosure;

FIG. 9 is a side view of one example of the swivel barrel utilized as a component or portion of the trolley weight of the fish attracting and catching device or system in accordance with the teachings of the present disclosure;

FIG. 10A is an environmental view of one example of the fish attracting and catching system illustrating the casting process utilizing the trolley system in conjunction with the shell in accordance with the teachings of the present disclosure;

FIG. 10B is an environmental view of one example of the fish attracting and catching system illustrating the line detachment or quick release feature from the trolley weight in accordance with the teachings of the present disclosure.

### DETAILED DESCRIPTION OF THE INVENTION

Disclosed herein is a device, system, and method of use for attracting and catching fish. The numerous innovative teachings of the present invention will be described with particular reference to several embodiments (by way of example, and not of limitation).

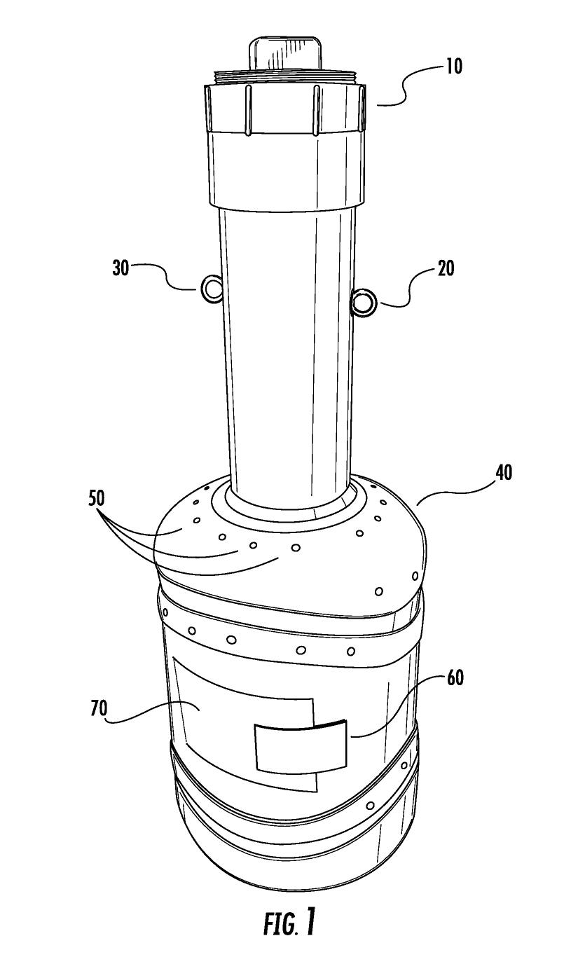

Reference is first made to FIG. 1, a front perspective view of one example of the fish attracting and catching device or system in accordance with the teachings of the present disclosure. In one embodiment, the fish attracting and catching system is comprised of a shell which is the entire structure illustrated in the figure. This component of the system may also be referred to as the “bait in a barrel”. In an embodiment the shell is comprised of a flotation portion 10, a hooking portion 20, 30, and a bait holding portion 40. In embodiments, the shell is not comprised of hooking portions 20, 30.

The flotation portion 10 of the shell may be permanently fixed or releaseably connected and provides buoyancy to the shell. In an embodiment, the flotation portion 10 may be made out of or be comprised of, for example, but not limited to foam, Styrofoam, or some other buoyant material. In another embodiment, the flotation portion may be a flotation device such as air filled pockets, balloons, or containers filled with buoyant material. As a further example, the flotation portion 10 may be made out of tubing filled with foam. The flotation portion 10 assists in setting the depths the shell will position itself. That is, depending on the buoyancy of the flotation portion 10 and the weight of the shell (by weighted objects and amount of water for example), the shell may be configured to remain at the surface or at varying depths down to the floor of the body of water.

The hooking portions 20, 30 are structures that allow other items such as, but not limited to hooks, rope, and fishing line to be attached or releasably connected to the shell. For example, these hooking portions 20, 30 allow the shell to be tethered to a boat, an item on the shore, or a pier. In an embodiment, the hooking portions 20, 30 are eyebolts. In another embodiment, the hooking portions 20, 30 are located on the flotation portion 10 of the device. In yet other embodiments, the hooking portions are located on the bait holding portion 40 of the device.

In a preferred embodiment, the bait-holding portion 40 is made of a clear or transparent material such as a plastic, glass, or polymer. This portion is used to hold bait, preferably live, to assist in the attraction of fish. In an embodiment, the bait holding portion is cylindrical in shape similar to a five-gallon plastic bottle being hollow in the inside. The clear or transparent bait holding portion 40 allows fish to be visually attracted by the bait being held in the bait holding portion 40 or by an illumination device being positioned in the bait-holding portion 40 or at another position on the shell. That is, the illumination device may be placed internally or externally on the flotation portion or the bait holding portion. In another embodiment, the bait-holding portion 40 is comprised of submersible openings 50 to aid in the bait holding portion filling and releasing water. That is when the shell is taken to a body of water such as but not limited to a river, lake, or ocean, the submersible openings 50 allow the bait holding portion 40 to fill with water and release any air being held in this portion. The submersible openings 50 may be placed anywhere on the shell or anywhere on the bait holding portion 40 but a preferable location is at the top of the bait holding portion 40. This bait holding portion 40 serves as a container to hold and keep alive (if desired) bait. The live bait will serve as an attractant for fish. The submersible openings also increase the scent release of the bait as well as a more close interaction with the bait and the surrounding aqueous environment. The bait will often attract small fish, which in turn will attract much larger fish. In an embodiment, the bait holding portion 40 is further comprised of a hatch 70 or cover opening 70 to allow access to inside of the bait holding portion 40. This opening 70 may also be comprised of a securement means 60 such as but not limited to a hooking mechanism, latch, and/or Velcro to insure the opening 70 remains closed and any bait does not escape.

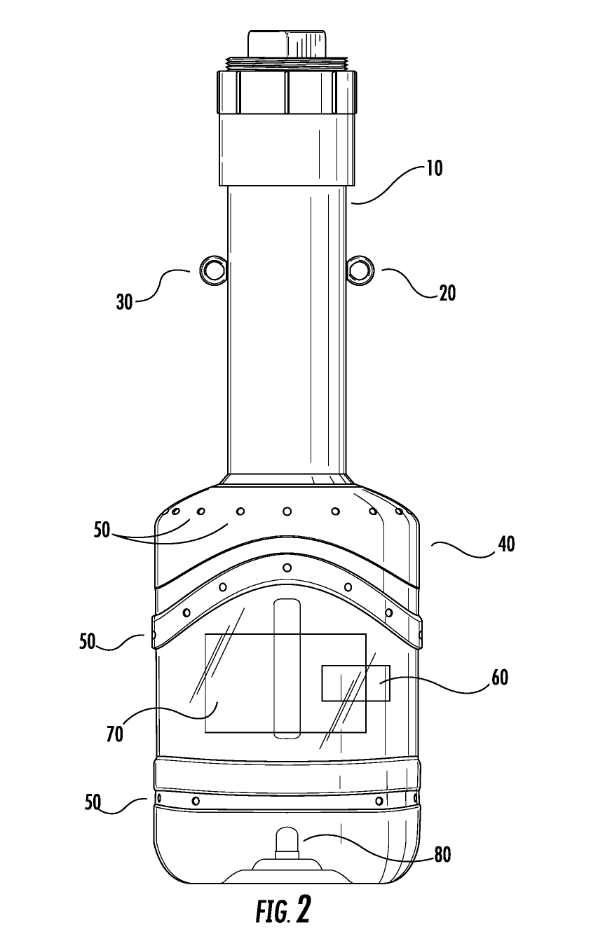

Reference is next made to FIG. 2, a front view of one example of the fish attracting and catching device in accordance with the teachings of the present disclosure. In an embodiment, the shell is further comprised of an illumination portion 80. The illumination portion 80 is a light source such as but not limited to an LED light. This light source helps in the attraction of fish. In an embodiment, the illumination portion 80 may be located anywhere on the shell. In another embodiment, the illumination portion 80 is located in/on the flotation portion 10. In yet another embodiment, the illumination portion 80 is located in/on the bait holding portion 40. When the light source 80 is located in the bait holding portion 40 as depicted, the entire bait holding portion is illuminated. This can provide a two prong fish attraction by the live bait and illumination within the bait holding portion 40. These embodiments allow the device/system to be used day or night and in fresh and salt water applications. In addition, this device/system helps facilitate the attraction of fish, keeps them in the area, and stimulates feeding.

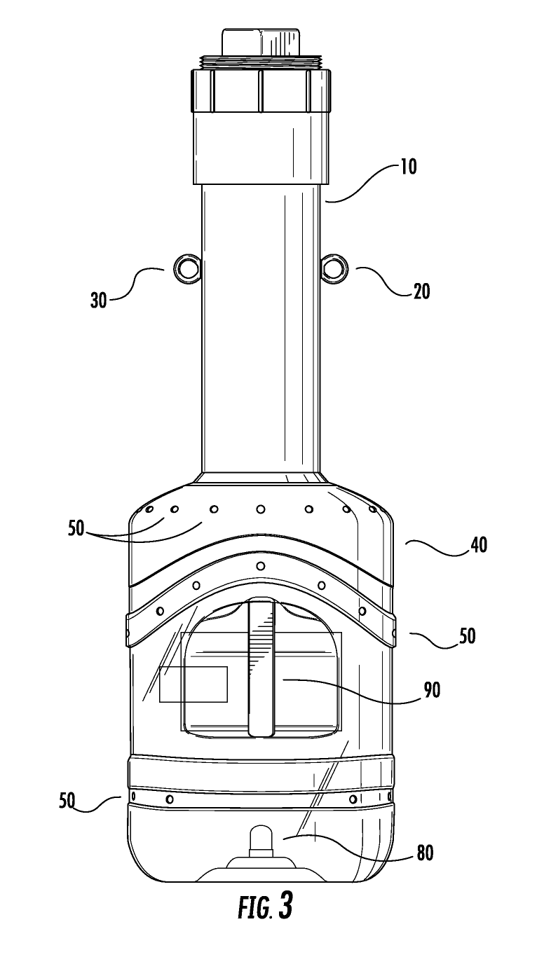

Reference is now made to FIG. 3, a back view of one example of the fish attracting and catching device in accordance with the teachings of the present disclosure. In an embodiment, the shell is further comprised of a handle portion 90 to assist in carrying and positioning the shell.

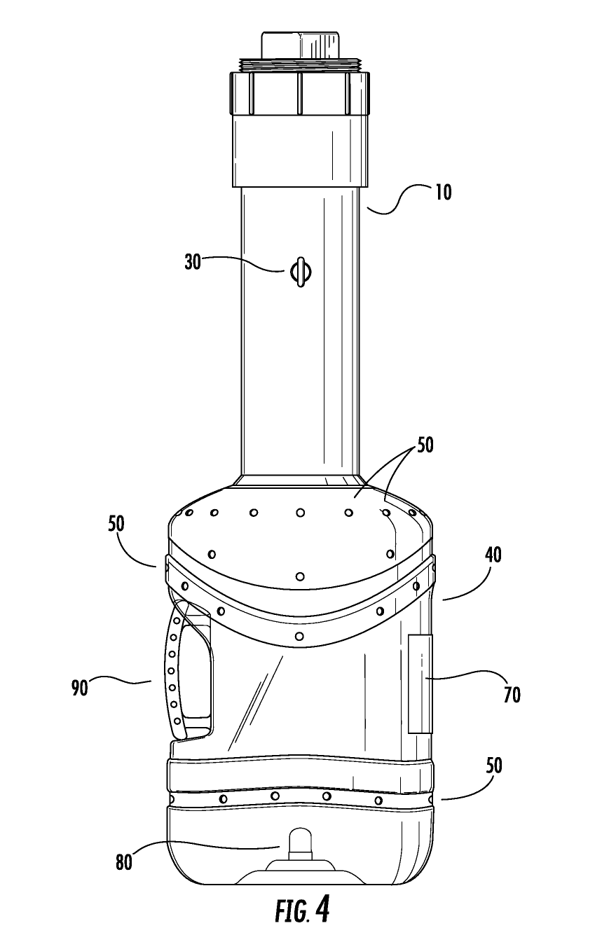

Reference is next made to FIG. 4, a left side view of one example of the fish attracting and catching device in accordance with the teachings of the present disclosure.

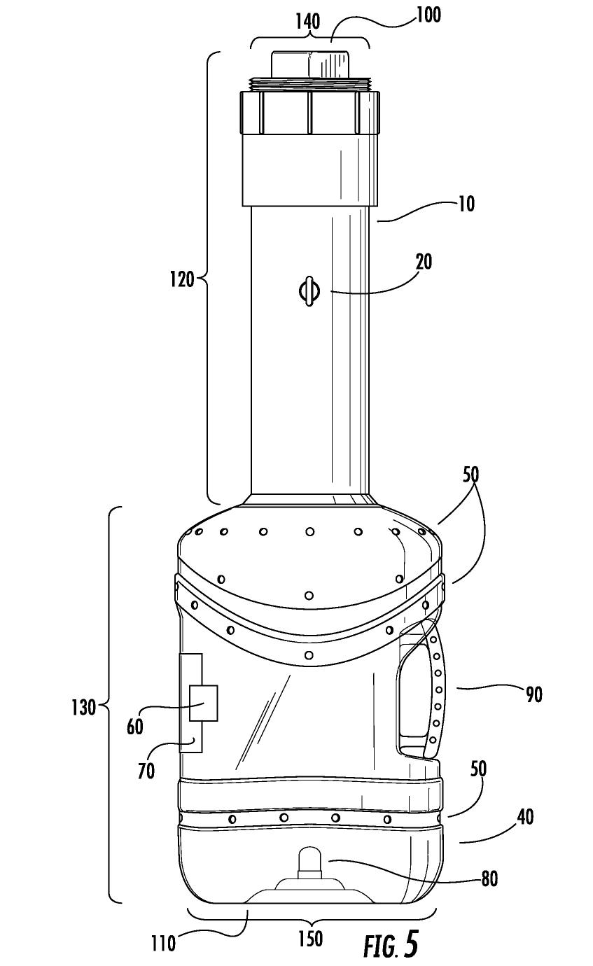

Reference is now made to FIG. 5, a right side view of one example of the fish attracting and catching device in accordance with the teachings of the present disclosure. Illustrated in this figure are the height 120 and width 140 dimensions of the flotation portion 10 as well as the height 130 and width 150 dimensions of the bait holding portion 40. Also labeled is the top of the shell 100 as well as the bottom of the shell 110.

Reference is next made to FIG. 6, a top side view of one example of the fish attracting and catching device in accordance with the teachings of the present disclosure.

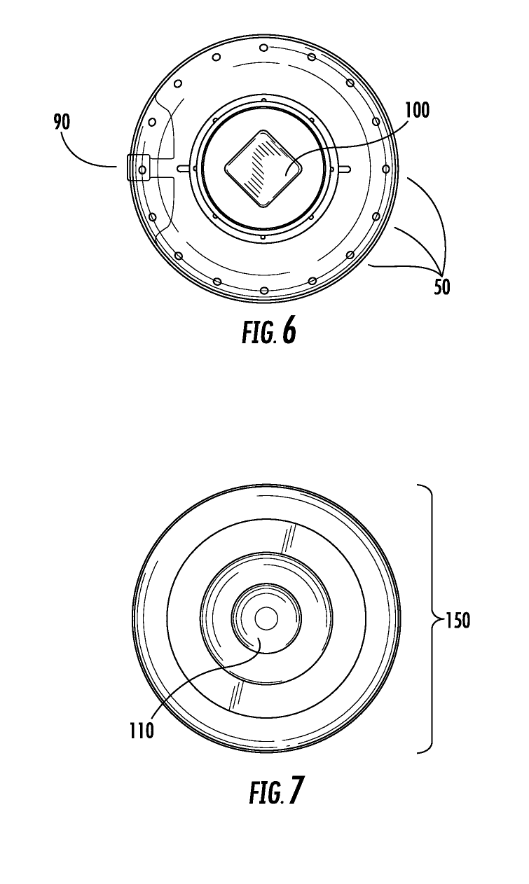

Reference is now made to FIG. 7, a bottom side view of one example of the fish attracting and catching device in accordance with the teachings of the present disclosure.

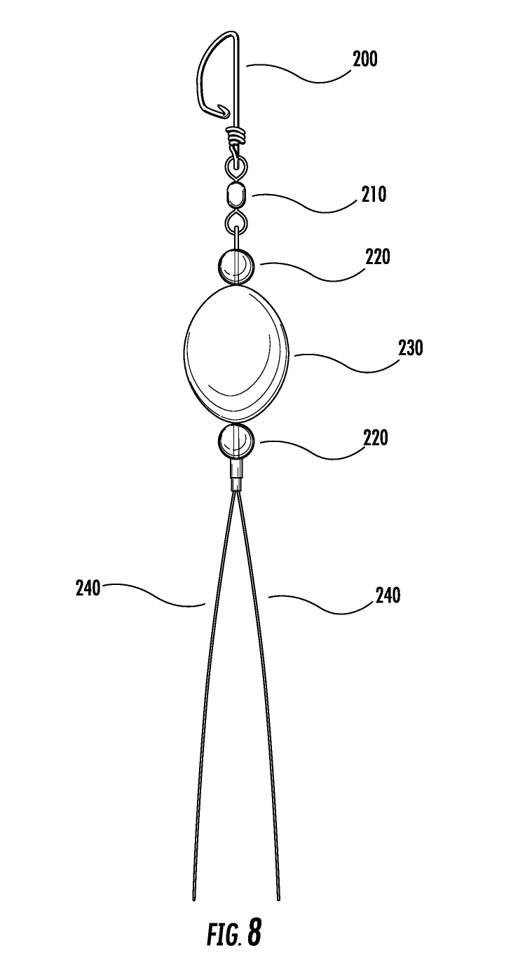

Reference is next made to FIG. 8, a side view of one example of the trolley weight utilized as a component of the fish attracting and catching device or system in accordance with the teachings of the present disclosure. In another embodiment the fish attracting and catching system is further comprised of a trolley system. Said trolley system being comprised of a trolley weight or referred to simply as the weight component. In another embodiment, the trolley system is further comprised of a trolley line. Illustrated in this figure is the trolley weight being comprised of a hooking portion or hooking means 200, a weight or weight portion 230, and a releasably attachment means or portion 240. The hooking portion 200 allows the trolley weight to be releasably attached to a trolley line as will be further discussed shortly. In an embodiment, the hooking means or portion 200 is a closure hook. The weight 230 may be of various weights sufficient enough to allow the trolley weight to traverse by gravity down a trolley line. The releasably attachment means or portion 240 in an embodiment are two wire legs as illustrated in the figure and can be bent to hold a shape. The releasably attachment means or portion 240 functions or is used to attach to the user's fishing line or hook. In another embodiment, the trolley weight is further comprised of at least one bead 220 and/or at least one swivel barrel connector 210.

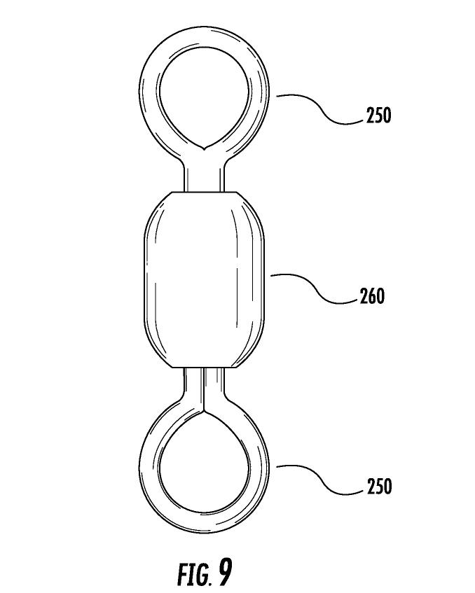

Reference is now made to FIG. 9, a side view of one example of the swivel barrel connector utilized as a component of the fish attracting and catching device in accordance with the teachings of the present disclosure. In an embodiment the swivel barrel connector is comprised of at least one eyelet 250 and a swivel body 260. The swivel body 260 allows the eyelets 250 to freely rotate about a longitudinal axis (as depicted) with their connection with the swivel body 260. The swivel barrel connector will be a part of the fisherman's fishing line and will usually be placed in close proximity to the hook. In a preferred embodiment, the swivel barrel connector is placed just above the hook on the fisherman's line.

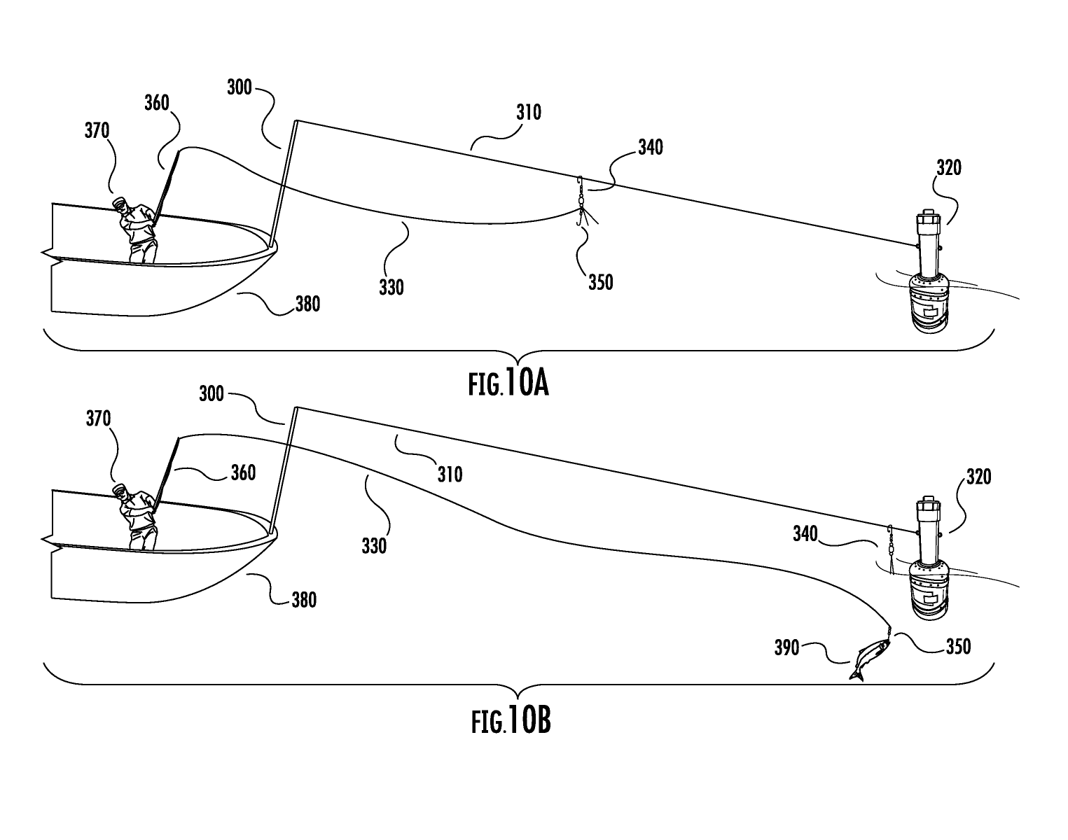

Reference is next made to FIG. 10A, an environmental view of one example of the fish attracting and catching system illustrating the casting process utilizing the trolley weight in accordance with the teachings of the present disclosure. Illustrated in this figure is a boat 380, a fisherman 370, the fisherman's rod 360, the fisherman's line 330, a trolley pole 300, a trolley line 310, a trolley weight 340, the swivel barrel connector with the fisherman's line hook 350, and the bait in a barrel shell 320. Shown is the trolley weight 340 attached to the trolley line 310 by the trolley weight's hooking means 200. The trolley line 310 is attached to the trolley pole 300 at a point higher than the shell 320 and the end of the trolley line 310 is attached to the shell 320 preferably at a hooking portion 20, 30. This allows the weight 230 on the trolley weight 340 to use gravity to traverse down the trolley line 310 to the shell 320. Prior to releasing the trolley weight 340, in an embodiment the fisherman will connect the releasably connection means or portion 240 of the trolley weight 340 to the fisherman's hook 350. Now, when the trolley weight 340 is released, a casting action/process is accomplished. That is the trolley weight 340 will traverse down the trolley line 310 taking with it, the fisherman's hook 350 and line 310 to the shell 320. In an embodiment where the trolley weight's 340 releasably connection means 240 are two wire legs, the wire legs are threaded through one or two eyelets 250 of the swivel barrel connector attached above the fisherman's hook 350 on his line and then released with the trolley weight 340 so the two (trolley weight 340 and swivel barrel connector/fisherman's hook 350) traverse down the trolley line 310 to the shell 320. The two wire legs 240 threaded through the eyelet(s) 250 keep the trolley weight 340 and swivel barrel connector/fisherman's hook 350 together. Once the two are down at the shell 320, the hook and bait 350 will be in the water next to the shell 320. That is the connection made between the trolley weight 340 and the fisherman's line 330, hook 350 and/or swivel barrel connector 350 will be at such a position on the fisherman's line 330 that the fisherman's hook and bait 350 are in the water to catch fish. As previously mentioned, the buoyancy of the shell 320 can be adjusted so that the shell 320 can be positioned at different depths in the body of water down to the floor of the river, lake, and/or ocean as examples. In this case, the trolley weight 340 and swivel barrel connector/fisherman's hook 350 will all be submerged if the shell 320 is submerged.

Reference is lastly made to FIG. 10B, a front perspective view of one example of the fish attracting and catching system illustrating the line detachment or quick release feature from the trolley weight in accordance with the teachings of the present disclosure. Illustrated in this figure is a fish caught 390. When a fish is caught with the system, the force the fish exerts when caught and attempting to get away will pull the swivel barrel connector/fisherman's hook 350 from the trolley weight 340. Now the fisherman can reel in the fish in a normal manner. This casting and reeling process allows for example a child, elderly, handicapped, physically challenged, or mentally challenged individual to cast his line without much physical effort.

In brief, the present invention relates to a device, system, and method of use for attracting and catching fish, wherein in one embodiment, it is comprised of an illuminated clear bait containment shell in conjunction with a trolley casting system.

The disclosed device, system, and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device, system, or method, except as may be outlined in the claims.

Alternative applications for this invention include using this device, system, and method of use for all types of fishing where fish are to be attracted and caught. This includes recreational fishing, scientific research applications, entertainment, academic and teaching environments, sporting, and commercial fishing applications. Consequently, any embodiments comprising a one piece or multi piece device or system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device, system, and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device, system, and/or methods disclosed and claimed herein can be made and executed without undue experimentation in light of the present disclosure. While the device, system, and methods of this invention have been described in terms of preferred embodiments, it will be apparent to those skilled in the art that variations may be applied to the device, system, and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A fish attracting device comprising:
a bait containment shell comprised of a flotation portion; and
a bait holding portion.

2. The fish attracting device of claim 1, wherein said bait containment shell is further comprised of an illumination portion.

3. The fish attracting device of claim 1, wherein said bait containment shell is further comprised of a hooking portion.

4. The fish attracting device of claim 1, wherein said bait containment shell is further comprised of a handle portion.

5. The fish attracting device of claim 1, wherein said bait containment shell is further comprised of at least one submersible opening.

6. The fish attracting device of claim 5, wherein said submersible openings are positioned on said bait holding portion.

7. The fish attracting device of claim 1, wherein said bait containment shell is further comprised of an illumination portion and a hooking portion.

8. The fish attracting device of claim 7, wherein said illumination portion is a light source and said bait containment shell is further comprised of at least one submersible opening.

9. The device of claim 1, wherein said bait holding portion is further comprised of a cover opening portion.

10. The device of claim 1, wherein said flotation portion is positioned on the top of said bait holding portion.

11. A fish attracting and catching system comprising:
a trolley system comprising a trolley line; and a trolley weight.

12. The fish attracting and catching system of claim 11, wherein said trolley weight is further comprised of a hooking portion, a weight portion, and an attachment portion.

13. The fish attracting and catching system of claim 12, wherein said attachment portion is comprised of at least one wire leg.

14. The fish attracting and catching system of claim 12, wherein said system is further comprised of a bait containment shell comprised of a
flotation portion; and a
bait holding portion.

15. The fish attracting and catching system of claim 14, wherein said bait containment shell is further comprised of an illumination portion and a hooking portion.

16. The fish attracting and catching system of claim 15, wherein said illumination portion is a light source and said bait containment shell is further comprised of at least one submersible opening.

17. The fish attracting and catching system of claim 16, wherein said bait holding portion is further comprised of a cover opening portion.

18. The fish attracting and catching system of claim 17, wherein said flotation portion is positioned on the top of said bait holding portion.

19. The fish attracting and catching system of claim 14, wherein said flotation portion is positioned on the top of said bait holding portion.

20. A fish catching device comprising a trolley weight comprised of:
a hooking portion for attaching to a trolley line;
a weight portion;
and an attachment portion for releasably attaching to a fishing line or hook.
